(19) United States
(12) Patent Application Publication
(10) Pub. No.: US 2015/0351421 A1
(43) Pub. Date: Dec. 10, 2015

(54) METHOD AND DEVICE FOR DRYING AND/OR ROASTING A FOOD

(71) Applicant: BÜHLER BARTH GMBH, Freiberg (DE)

(72) Inventors: Karsten VETTER, Stuttgart (DE); Tobias LOHMÜLLER, Freiberg (DE)

(21) Appl. No.: 14/760,729

(22) PCT Filed: Jan. 24, 2014
(86) PCT No.: PCT/EP2014/051394

§ 371 Date: Jul. 14, 2015

(30) Foreign Application Priority Data
Jan. 25, 2013 (EP) 13152759.0

(51) Int. Cl. A23G 1/00; A23G 1/06

(52) U.S. Cl. CPC A23G 1/002; A23G 1/06

(57) ABSTRACT

A method for drying and/or roasting a food which is performed in a treatment apparatus (2) comprising a treatment chamber (3) and at least one heating apparatus (4). The method comprises heating a gas by the heating apparatus (4) and further comprises heating an outside (5) of the treatment chamber (3) and conducting part or all of the heated gas through the treatment chamber where the heated gas is conducted through the treatment chamber before heating, after heating, or simultaneously with heating of the outside. The food in the treatment chamber is dried and/or roasted, due to heating, and/or by the heated gas conducted through the treatment chamber. During drying and/or roasting, a control value is determined on the basis of a measured value of a sensor. The heating and/or the conducting of heated gas through the treatment chamber is controlled depending upon the determined control value, particularly the moisture.

The invention relates to a method and a device for drying and/or roasting a food in a treatment apparatus according to the preamble of the independent claims.

A method and a device for drying and/or roasting cocoa bean pieces are known from EP 2 273 888 B1. In accordance with the disclosure, the cocoa bean pieces are located in a drum, which can be heated from the outside, through which drum a heated flow of clean gas is additionally conveyed for a transfer of heat by means of convection. A temperature or also a volume flow of the heated flow of clean gas can be controlled.

This previously known prior art has the disadvantage that the drying and/or roasting is sometimes aborted prematurely due to fluctuations of the moisture of the cocoa bean pieces to be dried, such that the moisture content at the end of the method may be too high and further processing such as grinding, is thus hindered or even made impossible. In addition, there may be the disadvantage that with the convective drying and/or roasting of the cocoa bean pieces the moisture content is reduced too severely and too quickly, such that that fat migrates from the interior of the cocoa bean pieces to the surface, such that this fat settles in the device and soils the device; in some circumstances this necessitates intensive cleaning of the device, which is complex and costly. A rapid surface drying of the cocoa bean pieces, also referred to as nibs, may additionally lead to a significantly increased yield loss, since pieces of the dried surface detach and are discharged. The drying must therefore be controlled so that the surface can be prevented from drying too quickly.

One object of the present invention is therefore to avoid the disadvantages of the known prior art, i.e. in particular to provide a method and a device with which a drying and/or roasting of a food is/are made possible, such that a more reliable and simplified further processing of the food is made possible and a throughput of food through the device is improved, inter alia by a lower cleaning outlay for the device and a reduction of the loss of food during the method. An additional object of the present of mission is to provide a method and a device for drying and/or roasting a food, with which the most flexible production possible of different flavor profiles of a roasted food is made possible.

These objects are achieved by a method and a device according to the independent claims.

The method according to the invention for drying and/or roasting a food is carried out in a treatment apparatus comprising a treatment chamber and at least one heating apparatus. In particular, cocoa beans and/or cocoa bean pieces are used as food. The method comprises the step of heating a first gas by means of the heating apparatus.

A flue gas/feed air mixture can be used as gas. In particular, clean air is used as gas.

The term “clean air” is understood in the context of the present application to mean air without flue gas, which for example may be produced when heating the air in the heating apparatus. By way of example, heated clean air can be produced in a heating apparatus, comprising a burner and a separate or integrated neat exchanger, wherein the clean air is heated in the heat exchanger without direct contact with waste gases from the burner, and therefore no chemical or biochemical reactions with flue gas are enabled.

The method according to the invention comprises heating an outer side of the treatment chamber. In particular, the outer side of the treatment chamber is heated by feeding some or all of the heated gas. It is thus conceivable that the outer side of the treatment chamber is heated by means of a separate heater and/or by means of feeding some or all of the heated gas. In particular, by heating the outer side of the treatment chamber, the food is dried and/or roasted by conduction of heat from the outer side of the treatment chamber into an interior of the treatment chamber, in which the food is arranged.

With this conductive guidance, a heat circuit can be closed advantageously, and in particular clean air can be guided in the circuit, which leads to a significantly reduced energy consumption.

The method according to the invention comprises passing heated gas, in particular some or all of the heated first gas, through the treatment chamber, wherein the passing through the treatment chamber can take place prior to the heating, after the heating, or at the same time as the heating of the outer side. When passing the heated gas through the treatment chamber, heat may thus be transferred by convection from the heated gas to the food located in the treatment chamber.

The method according to the invention comprises the drying and/or roasting of the food in the treatment chamber by the heating and/or by means of the passed-through heated gas. In other words, the food is dried and/or roasted by means of heat transfer by heat conduction from the heated outer side of the treatment chamber to the food and/or by means of heat transfer by convection from the passed-through heated gas to the food.

It is of course conceivable to guide a flue gas for drying and/or roasting the food through the treatment chamber and to heat the enter side of the treatment chamber likewise using the heated flue gas; this has the advantage that merely one heating apparatus is necessary for heating the outer side and for heating the gas to be passed through the treatment chamber, which is structurally more simple and cost-effective. Alternatively, it is conceivable to pass heated clean gas through the treatment chamber and to neat the outer side of the treatment chamber using the heated flue gas. In addition, if is conceivable to pass heated clean gas through the treatment chamber and to heat the outer side of the treatment chamber likewise using the heated clean gas, which is preferably guided in a circuit, in order to thus save energy.

The method according to the invention comprises determining a control variable, in particular the moisture of the food or a variable that provides information regarding the moisture of the food or of the food surface, in the treatment chamber during the drying and/or roasting on the basis of a measured value of a sensor, in particular of a moisture sensor. For this purpose, a sensor, in particular a moisture sensor, is arranged on and/or in the treatment chamber. The heating and/or the passing through of heated gas is/are regulated depending on the determined control variable, in particular the moisture.

For example, the temperature of the respective gas and/or the quantity of the gas can be adjusted for the regulation of the heating and/or of the passing through of heated gas. The convective heating may also be switched on or off as a whole.

The object is additionally achieved by a method for drying and/or roasting a food, in particular cocoa beans and/or cocoa bean pieces, in particular as described above, in a treatment apparatus. The treatment apparatus comprises a treatment chamber and at least one heating apparatus. Gas, in particular clean air, is heated by means of the heating apparatus.

The food is dried and/or roasted in the treatment chamber by heating of the treatment chamber, in particular from the outside, and/or by means of passed-through heated gas.

At least one sensor is arranged on and/or in the treatment chamber, wherein at least one control variable in the treatment chamber is determined during the drying and/or roasting on the basis of a measured value of the sensor, and wherein the heating, the passing through of heated gas and/or an extraction is/are regulated depending on the determined control variable. The at least one control variable is a quantify of food material guided out from the treatment chamber. The discharged material is discharged from the treatment chamber with a fume extractor, a gas extractor and/or with passed-through hot gas.

With a method for drying and/or roasting, what is known as fume extraction generally occurs, by means of which the released moisture and escaping gases are removed and, where necessary, a slight negative pressure is produced in the treatment chamber.

The food material guided out consists primarily of small product pieces, which are created when the surface of the food is heated too quickly and/or too intensely and pieces then detach from the surface of the food or food pieces break up or are crushed.

The sensor is preferably an inductive, optical or acoustic sensor, by means of which small product pieces are detected.

In an advantageous embodiment the control variable may be the moisture of the food or of the food surface, an oxygen quantity, a quantity of food material guided out from the treatment chamber, or combinations thereof.

The measured oxygen quantity and the quantity of food material guided out from the treatment chamber are dependent on the degree of drying and/or roasting and are therefore directly related to the moisture of the food, similarly to a measured moisture in the treatment chamber.

The moisture is preferably determined by means of a microwave sensor.

The heating is advantageously regulated via a setting of the gas path through the housing, in particular by defining regions of the housing through which gas is preferably passed.

In order to adjust the gas path, at least one hot gas entry opening of the housing and/or at least one hot gas exit opening of the housing can be opened and/or closed, for example.

By adjusting the gas path, a homogeneous heat distribution or an inhomogeneous heat distribution can be achieved for the conductive heating. If the gas flows uniformly around she entire treatment chamber, a homogeneous heating by conduction is enabled. If the gas flows only past parts of the treatment chamber, an inhomogeneous heat distribution is created.

In order to achieve a certain temperature profile, guiding elements are preferably mounted on the outer side of the treatment chamber and ensure a longer residence time of the gas at the respective portions of the outer side of the treatment chamber. With a uniform arrangement of guiding plates or slats, a homogeneous temperature distribution can be achieved in particular. Alternatively, the guiding elements can be arranged such that gas does not flow at all onto certain portions of the outer side of the treatment chamber, and these portions therefore remain cooler.

The guiding plates are preferably adjustable, such that the gas path can be adjusted via the setting of the guiding plates.

Within an inhomogeneous heat distribution, the food product can be transferred from cooler into warmer regions of the treatment chamber and vice versa. The food product can also circulate through the respective regions a number of times. This process is referred to as a polycyclic relaxation process (PRP). The transport of the food within the treatment chamber is achieved by an appropriate internal design, for example by a screw conveyor, by preferably axially mounted agitator or distributor elements, or by guiding plates.

In this way, a method that is gentle for the food product is made possible, which method leads to a more uniform distribution of the water in the product to be dried and/or to be roasted, and which leads to a reduction of the formation of small components.

The method according to the invention has the advantage that, by determining the control variable, in particular the moisture, during the drying and/or roasting of the food, the moisture of the food following completion of the method can be accurately set. The treated food can thus be optimized for the further method steps, such as grinding in a cocoa mill.

In addition, by determining the moisture during the treatment, that is to say the drying and/or roasting, the food can be prevented from drying too quickly, and for example fat can be prevented from being conveyed from the interior of the food to the surface and from settling in the treatment chamber, which may entail cleaning, which may be laborious. Alternatively or additionally, it is possible to avoid the creation of too many small product pieces, which are discharged and reduce the yield. In addition, by means of an appropriate selection between convective heat transfer, conductive heat transfer or conductive and convective heat transfer, desired color and/or flavor profiles of the treated food can advantageously be achieved; this is possible for example by an appropriate selection of the order of the heating of the outer side and the passing of the heated gas through the treatment chamber.

The method according to the invention has the further advantage that shorter treatment times, such as shorter roasting times, can be achieved by a quicker roasting of the food by means of convective heat transfer; in the case of the roasting of cocoa bean pieces in accordance with the method according to the invention, a reduction of the roasting time by up to 60% can be achieved, which signifies an increase in capacity with constant machine masses by 150%. In addition, the fat migration from the food to the surface of the food can advantageously be fundamentally avoided by the method according to the invention; a cleaning effort of the treatment apparatus, which may be caused by deposition of fat encouraged by the fat migration to the surface of the food, is thus reduced; in addition, the fat migration may lead to a loss of weight of treated food; by way of example, this may lead in the case of treatment of cocoa bean pieces to a weight loss of approximately 1%, which is why an avoidance of fat migration during the processing of usually several thousand metric tons of cocoa bean pieces in the treatment apparatus per year may lead to significant economic advantages.

The drying and/or roasting method is regulated preferably by a reduction in good time of the heat feed, a switchover to purely conductive heating, a reduction of the product removal, a termination of the heating and/or the complete removal in good time of the food product from the treatment chamber. The abrasion and the accompanying formation of small pieces are thus reduced, leading to a yield reduction in the region of a single-digit percentage.

In particular, the heating apparatus can be designed in such a way that a first volume flow of heated gas is produced, which is guided to the outer side of the treatment chamber. In addition, the heating apparatus can be designed such that a second volume flow of heated gas can be produced, wherein the second volume flow is guided through the treatment chamber. Alternatively, it is of course also conceivable that only one volume flow of heated gas is produced, which is guided to the outer side of the treatment chamber and through the treatment chamber sequentially or in parallel.

A volume flow regulation apparatus for the volume flow of heated gas and/or of gas fed into the heating apparatus is preferably arranged in she treatment apparatus. The volume flow is regulated depending on the determined control variable, in particular the moisture, the oxygen quantity, the quantity of food material guided out from the treatment chamber, or combinations thereof.

This has the advantage that the conductive and connective neat transfer to the food can be regulated by the regulation of the volume flow of passed-through heated gas for a further improved setting of the course over time of the moisture of the treated food.

Here, the volume flow can be regulated depending on the measured control variable by means of a valve of which the cross section can be varied, or also by opening and closing the valve at appropriate time intervals. It is also conceivable to use a suction apparatus, such as a fan, in particular an extractor fan, with variable suction power in order to regulate the volume flow.

Alternatively, a regulation of a temperature of the heated gas is also conceivable for example, in particular depending on the determined moisture, in order to adjust the moisture of the food as a function of time in accordance with requirements.

The volume flow is preferably regulated in such a way that a maximum flow rate of the heated gas at an outlet from the treatment chamber is less than 25 m/s and preferably less than 20 m/s. In particular, the maximum flow rate is regulated in a time-dependent manner and/or in accordance with process requirements.

This has the advantage that smaller pieces of the food fundamentally are not removed by the volume flow guided through the treatment chamber; these smaller pieces are for example already present when the food is introduced into the treatment chamber or are created by the treatment process in the treatment chamber. Since smaller piece that would be removable by the volume flow are often flavor carriers of the food, a removal of these smaller pieces is often undesirable. In addition, a removal of smaller pieces by the volume flow has the disadvantage that a loss of food to a greater extent may occur, which is economically disadvantageous.

In particular, the maximum flow rate at the outlet of the treatment chamber is set in the range from 2 m/s to 20 m/s. More particularly, the time-dependent regulation of the maximum flow rate is performed in such a way that the maximum flow rate decreases as the method is performed; this has the advantage that smaller pieces are not carried away by the volume flow, although the moisture and therefore the specific weight decreases as a result of the drying and/or roasting; due to the decrease of the specific weight, the smaller pieces could be carried away more easily at constant maximum flow rate, which can thus be prevented.

The volume flow can also be set to a minimum, and in a borderline case can be switched off completely, and the heating can be switched to conductive heating.

The volume flow is preferably regulated downstream of the treatment chamber. This has the advantage that the volume flow can be regulated more reliably, since foods are often products with variable bulk density, which therefore provide the volume flow guided through the treatment chamber for example with a flow resistance that also changes over time, which can be compensated for by a regulation of the volume flow downstream of the treatment chamber.

Cocoa beans and/or cocoa bean pieces pre-treated in an alkaline environment are preferably roasted as food. The pre-treated cocoa beans and/or cocoa bean pieces in particular have a starting moisture of greater than 10% by weight and in particular of greater than 20% by weight.

The roasted food preferably has a final moisture of less than 3% by weight and in particular less than 2% by weight.

In the context of the present application the starting moisture is understood to mean the moisture of the food that the food has prior to the onset of the drying and/or roasting. In the context of the present application a final moisture is the moisture that the food has following completion of the drying and/or roasting. In the context of the present application the specification of the moisture in percent by weight is understood to mean a moisture content in relation to the dry weight of the food.

The roasting of the food and in particular of cocoa beans and/or cocoa bean pieces to a final moisture of less than 3% by weight has the advantage that the roasted cocoa beans and/or cocoa bean pieces can be reliably processed in a cocoa mill.

The treatment chamber is preferably rotatably mounted. Alternatively or additionally, a mixer is arranged in the treatment chamber, wherein the food is recirculated by a rotation of the treatment chamber and/or an actuation of the mixer.

The internal design of a treatment chamber designed as a drum in particular assists the heterogeneous heating, i.e. when heating is performed with inhomogeneous heat distribution. The design is configured for targeted thorough mixing, in which case the product to be dried and/or roasted repeatedly crosses through hotter and cooler zones (polycyclic relaxation process [PRP]).

In this way, even with inhomogeneous heating, a gentle treatment, a uniform distribution of the water in the product to be dried and/or roasted and a reduced formation of small components are achieved, which reduces the yield loss and leads to a homogeneous formation of flavor and color.

The internal design of the treatment chamber can also assist the heating with homogeneous neat distribution, wherein the food can be treated more uniformly by the recirculation.

The rotatability of the treatment chamber and the simultaneous arrangement of a mixer in the treatment chamber allow an optimal recirculation of the food depending on the food in the treatment chamber. By way of example, the speed of rotation of the treatment chamber and/or of the mixer can be adjusted in accordance with the food.

The speed of rotation can be set such that different temperature zones are passed through optimally in view of obtaining a chemical reaction, for example oxidation, and/or in view of minimizing the production of fine components.

In particular, the treatment chamber, preferably a drum, has a filling level in relation to the total volume of the treatment chamber in the range from 50% to 80% and preferably from 60% to 70%.

In particular, a filling of the treatment chamber with the food has a weight of at least 0.5 metric tons and optionally of at least 4 metric tons.

The treatment apparatus is preferably operated in a partial recirculation mode. The partial recirculation mode is implemented in particular in such a way that heated gas fed to the outer side is returned into the heating apparatus at least in a proportion of 50% and preferably at least in a proportion of 70%. Fresh gas is preferably mixed with the returned gas.

This has the advantage that the energy requirement for heating the outer side is reduced.

Where appropriate, the treatment apparatus has a return apparatus for returning the gases, wherein in particular a filter is arranged in the return apparatus in order to filter entrained particles and/or substances, such as fats or oils, such that these fundamentally are not returned into the heating apparatus.

The moisture is preferably determined by means of a microwave sensor. Microwave sensors of this type are known for example from the company TEWS Elektronik and can be formed for example as tubular sensors, planar sensors or also fork sensors.

The use of a microwave sensor has the advantage that the moisture of the food in the treatment chamber can be determined reliably and quickly. For this purpose, a microwave sensor formed as a planar sensor can be used, for example, said sensor being arranged in the treatment chamber; as a result of the rotation of the treatment chamber, which is designed in particular as a roasting drum, and/or as a result of the actuation of the mixer, food can be conveyed over the measuring surface of the planar sensor during operation as the method for drying and/or roasting is performed, and the moisture of the food during the treatment can be determined.

The treatment apparatus preferably comprises a data processing unit, in which value pairs of degree of roasting and moisture of the food stored.

The moisture and/or the degree of roasting can also be determined in the treatment chamber by means of a measurement or the oxygen content, which is determined via an appropriate sensor as a control variable or critical process parameter. In particular, the degree of roasting can be determined by means of the change of the oxygen content in the treatment chamber. The moisture of the food is determined via the measurement and in particular the change of the oxygen content in the treatment chamber and the stored value pairs. The oxygen content is preferably determined by means of a lambda probe and particularly preferably by means of a second lambda probe additionally arranged in the heating device.

The determination of the moisture of the food via a measurement of the oxygen content, that is to say the oxygen partial pressure, has the advantage that lambda probes in practice are available reliably and economically. Lambda probes of this type are obtainable for example as the planar broadband lambda probe LSU 4.9 from the company Bosch.

When roasting a food, such as cocoa beans and/or cocoa bean pieces, an oxidation of components of the food takes place; this oxidation is referred to in the case of the roasting of cocoa as a Maillard reaction. As a result of the oxidation for example of carbon in the food, the oxygen content in the treatment chamber is reduced; by means of a lambda probe arranged on and/or in the treatment chamber, the reduction of the oxygen content and/or the change of the oxygen content in the treatment chamber during the roasting can be measured. By way of example, the oxygen content can thus be reduced in the treatment chamber in the range from 0.2% to 0.8%; a reduction of this type of the oxygen content in the treatment chamber can be measured by means of lambda probes currently available. In addition, a second lambda probe is preferably arranged in the heating apparatus in order to determine in the heating apparatus the oxygen content of the heated gas fed into the treatment chamber, so as to be able to better detect fluctuations of the oxygen content; the accuracy of the measurement of the oxygen content in the treatment chamber is further improved as a result.

A further aspect of the present invention concerns a method for verifying a performed sterilization during a method for drying and/or roasting a food, in particular as described above, in a treatment apparatus comprising a housing, a treatment chamber and at least one heating apparatus, wherein additional moisture is introduced into the treatment chamber and a sterilization peak is detected in the measurement curve of a moisture sensor, in particular of a microwave sensor.

The measured values of the moisture sensor provide information with regard to whether added moisture actually enters the treatment chamber. Previously, this could be verified only indirectly, for example via the occurrence of a pressure rise in a pressure measurement.

The monitoring of the decreasing moisture during the drying and/or roasting of a food gives an indication of the suitable moment in time for introducing additional moisture, which ensures a sterilization of the food.

Only when the moisture peak is visible in the measurement curve has the moisture actually entered the treatment chamber and reached the product, whereby a positive detection for a performed sterilization is given.

It is advantageously ensured that sufficient moisture enters the treatment chamber so that the entire food quantity is subjected to the sterilization process. To this end, the area of the peak in the measurement curve is determined, providing information regarding the quantity of moisture in the treatment chamber.

A further aspect of the present invention concerns a treatment apparatus for drying and/or roasting a food. In particular, cocoa beans and/or cocoa bean pieces are used as food. The treatment apparatus is suitable for carrying out a method as described above. The treatment apparatus comprises a treatment chamber and at least one heating apparatus for heating a gas. A sensor, in particular a moisture sensor, is arranged on and/or in the treatment chamber for determining a control variable, in particular the moisture, of the food in the treatment chamber during the drying and/or roasting. The treatment apparatus is designed such that the drying and/or roasting can be regulated depending on the determined control variable, in particular the moisture.

The treatment apparatus preferably comprises an adjustment apparatus, by means of which the passing of heated gas through the treatment chamber can be adjusted in order to achieve convective heating.

The device according to the invention is suitable for carrying out the method according to the invention and therefore has all the advantages of the above-explained methods.

In an advantageous embodiment the control variable may be the moisture of the food or of the food surface, an oxygen quantity, a quantity of food material guided out from the treatment chamber, or combinations thereof.

In particular, a sensor for determining the quantity of food material guided out from the treatment chamber is provided, in particular an inductive, an optical, or acoustic sensor.

A moisture sensor is preferably provided, which is formed as a microwave sensor. This has the advantage that the moisture of the food in the interior of the food can be determined by means of the microwave sensor, which enables a better regulation of the method. In other words, a depth measurement of the moisture of the food can be performed, and not just a determination of the surface moisture; the surface moisture is often measured by way of example using infrared sensors, wherein a determination merely of the surface moisture is often insufficient for the regulation of the method.

The treatment device may additionally have a guiding device, by means of which the heated gas can be guided through the housing over different paths. For this purpose, the housing for example has at least two closable hot gas entry openings and/or at least two closable hot gas exit openings.

Alternatively or additionally, compartment walls, which in particular are movable, can be provided, which allow the hot gas to flow in only in certain separable portions of the housing.

In one embodiment a moisture sensor can be provided as a sensor, said moisture sensor preferably being formed as a lambda probe, for measuring the oxygen content in the treatment chamber. In particular, the treatment apparatus comprises a data processing unit, in which value pairs of degree of roasting and moisture of the food are stored; the degree of roasting can be determined by means of a measurement and in particular the change of the oxygen content in the treatment chamber, wherein the moisture of the food can be determined via the measurement and in particular the change of the oxygen content in the treatment chamber and the stored value pairs.

At least two lambda probes are particularly preferably arranged in the treatment apparatus, wherein a second lambda probe of the two lambda probes is arranged on and/or in the heating apparatus in order to measure the oxygen content in the heating apparatus.

A volume flow regulation apparatus for the volume flow of heated gas and/or of gas fed into the heating apparatus is preferably arranged in the treatment apparatus. The volume flow can be regulated depending on the determined moisture.

The volume flow regulation apparatus is particularly preferably arranged downstream of the treatment chamber.

The treatment chamber is preferably rotatably mounted. Alternatively or additionally, a mixer is arranged in the treatment chamber. The food can be recirculated by a rotation of the treatment chamber and/or an actuation of the mixer. In particular, the treatment chamber is formed as a drum having a drum axis, about which the drum is rotatably mounted.

The treatment apparatus preferably comprises a return apparatus for returning heated gas fed to the outer side into the heating apparatus. The treatment apparatus is designed in such a way that a partial recirculation mode can be implemented, wherein fresh gas preferably can be mixed with the returned gas.

A further aspect of the present invention relates to a treatment apparatus for drying and/or roasting a food. The treatment apparatus is in particular formed as the treatment apparatus described above. In particular, the treatment apparatus is suitable for carrying out the above-described method. The treatment apparatus comprises a treatment chamber, which during operation is in contact with the food, and at least one heating apparatus for heating a gas, wherein a portion of an outer wall of the treatment chamber has thermal insulation. The thermal insulation of the treatment apparatus is formed in particular as a double wall. The portion comprising the thermal insulation is arranged preferably in the region of the outer wall in which the heated gas can be fed from the heating apparatus to the outer wall. In other words, thermal insulation is not provided over the entire outer wall.

This has the advantage that, in the region in which the heated gas for the conductive heating comes into contact with the outer wall of the treatment chamber, the food is not heated too intensely, and a risk of sticking of food in the treatment chamber is reduced. Usually, with conductive heat transfer from the outer side to the food, the heated gas is guided in a portion to the outer wall of the treatment chamber and is then conveyed along the outer wall, such that the heated gas is circulated around the treatment chamber. In the portion in which the heated gas contacts the outer wall, an excessive heating of the outer wall and therefore of the food in the treatment chamber may therefore occur, however this is disadvantageous for the product quality and the operation of the device; where applicable an excessive roasting of part of the product may occur, and additional cleaning steps may be necessary when the food sticks to the treatment chamber. In addition, the arrangement of the thermal insulation has the advantage that a more uniform heat distribution along the treatment chamber can be ensured, which may prevent an over-roasting of the food.

In the context of the present application, thermal insulation in a portion of an outer wall of the treatment chamber is understood to mean that in this portion the coefficient of thermal conduction from the outer side to the inner side of the treatment chamber is lower than outside this portion.

A further aspect of the present invention relaxes to a treatment apparatus for drying and/or roasting a food. The treatment apparatus is formed in particular similarly to the above-described treatment apparatus. In particular, the treatment apparatus is suitable for carrying out the above-described method. The treatment apparatus comprises a treatment chamber, which during operation is in contact with the food, and at least one heating apparatus for heating a gas. Gas-guiding elements are provided in the treatment apparatus and are located in particular at least on a portion of an outer wall of the treatment chamber.

The gas-guiding elements promote the heat transfer from hot gas to the treatment chamber by increasing the residence time of the hot gas in certain regions and/or the surface for the heat transfer. The energy balance is improved as a result of the increased heat transfer.

By way of example, gas-guiding plates or slats can be provided as gas-guiding elements on the outer side of the treatment chamber, or gas channels, which lead around the treatment chamber.

The gas-guiding elements can be arranged such that the hot gas is forced around the treatment chamber over a meandering path, which significantly extends the time for the heat transfer.

Depending on the arrangement of the gas-guiding elements, a homogeneous heat distribution or an inhomogeneous neat distribution is promoted.

Further features and advantages of the invention will be explained in greater detail hereinafter on the basis of exemplary embodiments for improved understanding, however the invention is not to be limited to the exemplary embodiments. In the drawings:

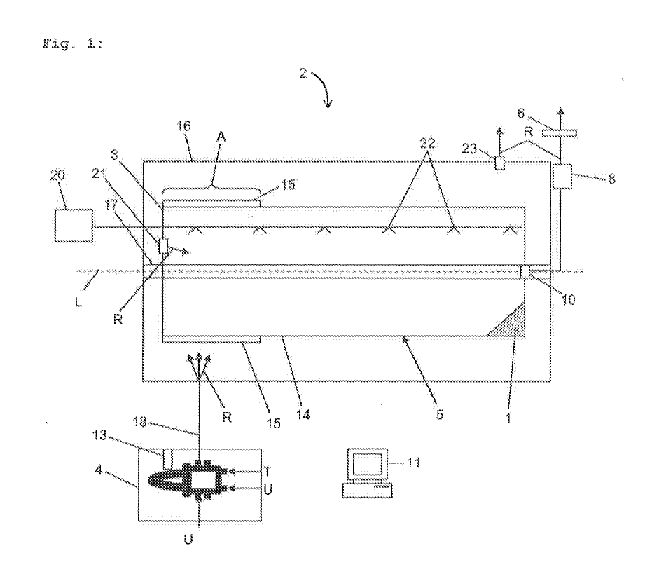

FIG. 1: shows a schematic illustration of a treatment apparatus according to the invention in a partially sectional side view with a volume flow regulation apparatus;

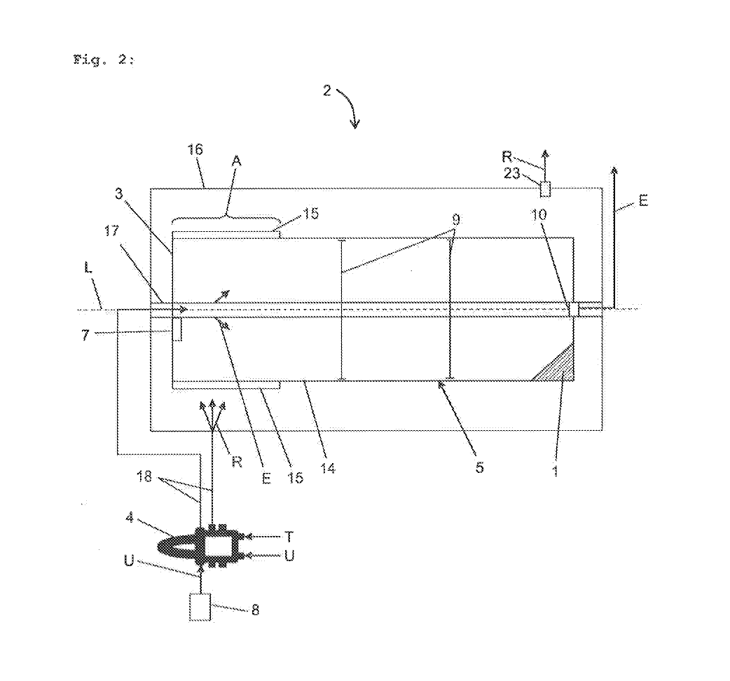

FIG. 2: shows a schematic illustration of an alternative treatment apparatus according to the invention in a partially sectional side view;

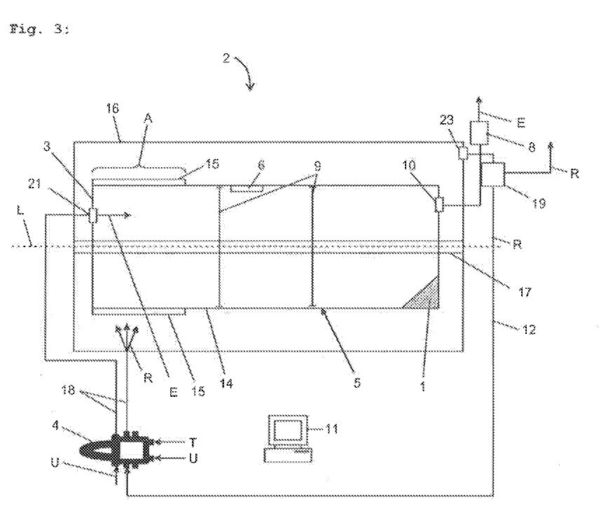

FIG. 3: shows a schematic illustration of a further alternative treatment apparatus according to the invention with a return apparatus;

FIG. 4: shows a partially sectional side view of a treatment chamber according to the invention;

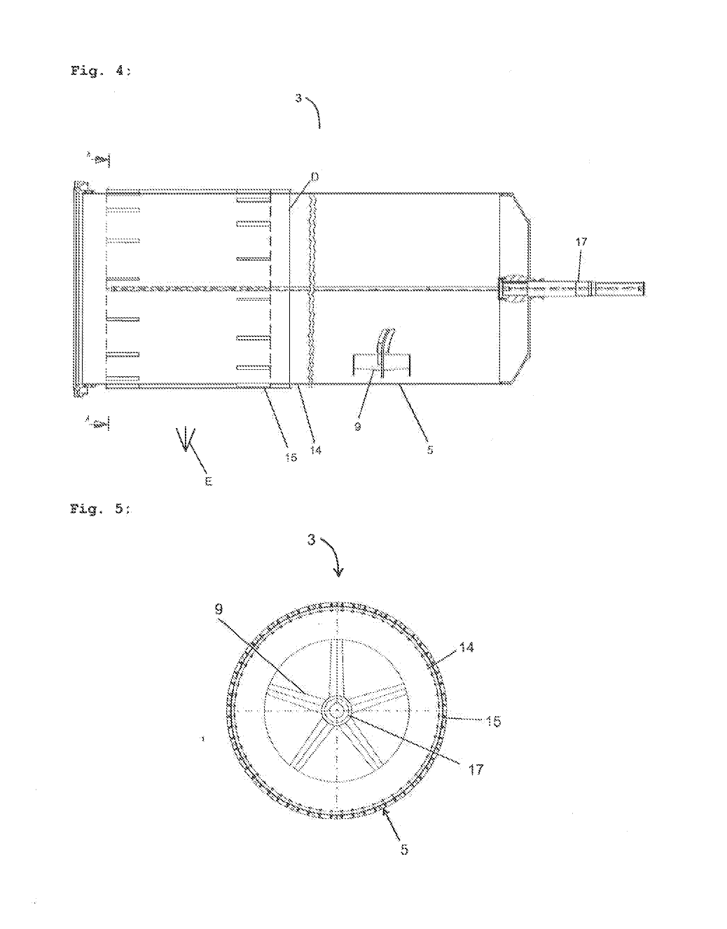

FIG. 5: shows a sectional illustration of the treatment chamber illustrated in FIG. 4;

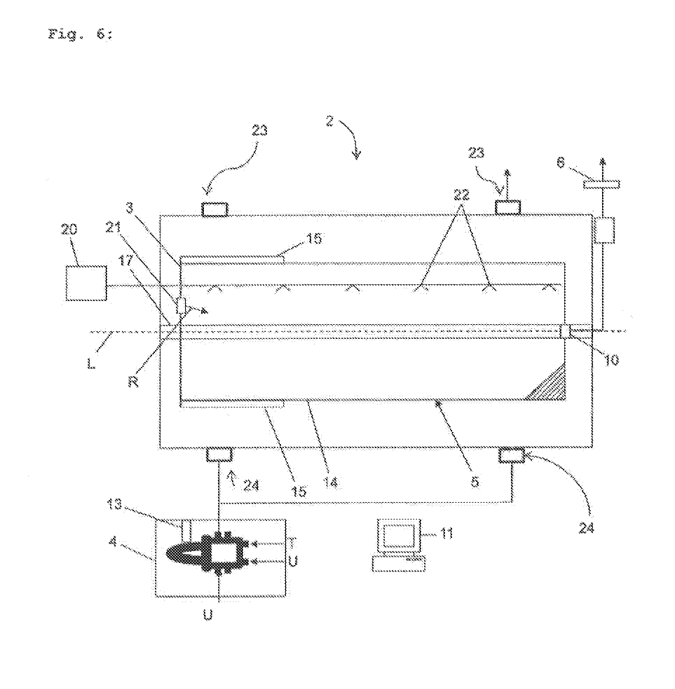

FIG. 6: shows a schematic illustration of an alternative treatment apparatus according to the invention with two hot gas entry openings and two hot gas exit openings in a partially sectional side view;

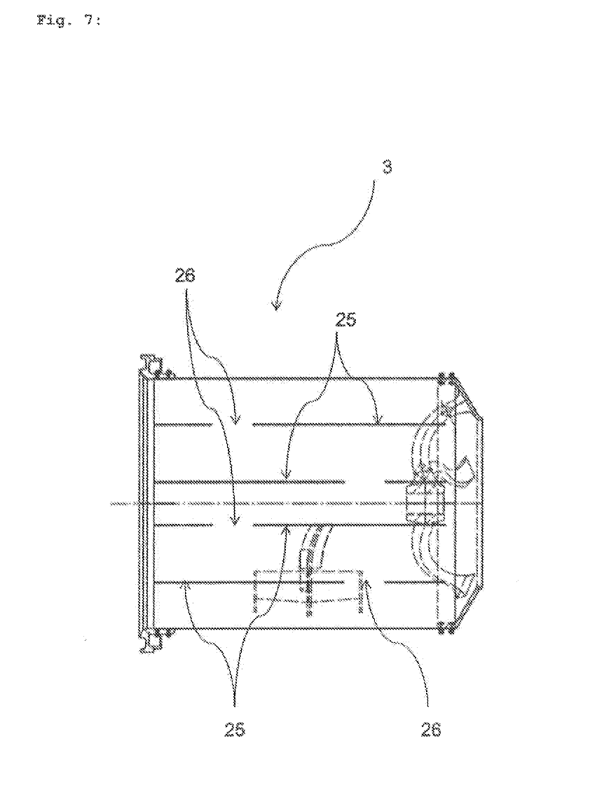

FIG. 7: shows a partially sectional side view of a treatment chamber according to the invention with gas-guiding elements;

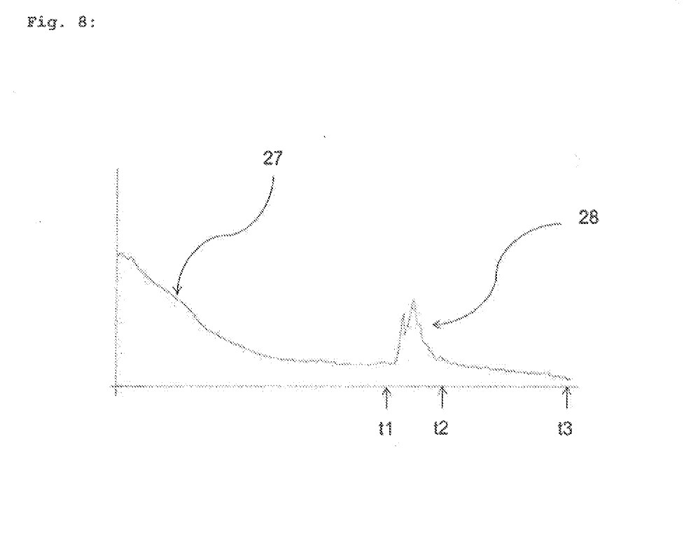

FIG. 8: shows a measurement curve of a microwave sensor during a method for drying and/or roasting a food product.

In FIG. 1 a treatment apparatus 2 according to the invention for drying and/or roasting cocoa bean pieces 1 is illustrated in a schematic illustration in a partially sectional side view.

The treatment apparatus 2 comprises a treatment chamber 3, which is arranged in a housing 16. The treatment chamber 3 is mounted on a shaft 17 rotatably about a longitudinal axis L of the shaft 17. The treatment chamber 3 is formed as a drum.

Thermal insulation 15 formed as a double wall is arranged on an outer wall 14 in a portion A. Here, the portion A is the region of an outer side 5 of the treatment chamber 3 in which a heated flue gas R is fed to the outer side 5 of the treatment chamber 3. The heated flue gas R flushes over the treatment chamber 3 and in so doing heats this on the outer side 5, wherein the outer wall 14 is heated, as are the cocoa bean pieces 1 by means of conduction. The heated flue gas R can then be conveyed from the housing outlet 23; for this purpose a valve and/or a pump can be arranged in the housing outlet 23 or in a line connected downstream thereto for controlling and/or regulating the conveyance of the heated flue gas R through the housing outlet 23.

The treatment chamber 3 at an end face has an inlet 21 for heated flue gas R into the treatment chamber 3. Here, the heated flue gas R is led through the treatment chamber 3 and is conveyed from the treatment chamber 3 through an outlet 10. A volume flow regulation apparatus 8 is arranged downstream of the treatment chamber 3 and by way of example may be an extractor fan. By means of the flow regulation apparatus 8, the volume flow of heated flue gas R through the treatment chamber 3 can be regulated. Here, the regulation is performed in such a way that a maximum speed of the heated flue gas R conveyed through the outlet 10 is less than 20 m/s.

A lambda probe 6 is arranged in the treatment apparatus 2, by means of which probe an oxygen content, i.e. an oxygen partial pressure, can be measured. The lambda probe 6 is connected to a data processing unit 11. Value pairs formed of oxygen content and degree of roasting are stored in the data processing unit 11, wherein a moisture content of the cocoa bean pieces 1 can be derived from the degree of roasting. A second lambda probe 13 is arranged in a heating apparatus 4 in order to be able to compensate for fluctuations in the oxygen content that may be produced by the process of heating the flue gas R. The second lambda probe 13 also is connected to the data processing unit 11.

The heating apparatus 4 comprises the second lambda probe 13 and also a furnace, which can heat the ambient air U to produce heated flue gas R. The heated flue gas R is conveyed to the treatment apparatus 2 by means of a feed apparatus 18, which is formed here as a pipeline.

The treatment apparatus 2 additionally comprises an application apparatus 2 for acting on the cocoa bean pieces 1, for example with water, steam, air or also a solution, which for example Pay be alkaline. For this purpose, a line comprising nozzles 22 is connected to the application apparatus 20 for acting accordingly on the cocoa bean pieces 1. A treatment of this type can be per formed tor example before or also after the drying and/or roasting of the cocoa bean pieces.

The cocoa bean pieces 1 can be fed into the treatment chamber 3 via tire outlet 10, via which heated gas can be removed during operation.

In FIG. 2 an alternative treatment apparatus 2 according to the invention is illustrated in a schematic illustration in a partially sectional side view.

Like reference signs designate similar features in all figures and are therefore only explained again where necessary.

In contrast to the treatment apparatus according to FIG. 1, the treatment apparatus according to FIG. 3 has separate feed channels of the feed apparatus 18 for heated flue gas R and heated clean gas E. A propellant T is burned in tire heating apparatus 4 with ambient air U in order to produce a heated flue gas R. The heated flue gas R is conveyed directly through the feed apparatus 18 into the housing 16 to the outer side 5 of the treatment chamber 3 in order to heat this. In addition, a heat exchanger is arranged in the heating apparatus 4 for heating ambient air U for producing heated clean gas E. The flue gas therefore is not in fluid connection with the heated clean gas E, such that the flue gas is not conveyed into the treatment chamber 3.

For feeding the ambient air U, a volume flow regulation apparatus 8 is arranged upstream of the heating apparatus 4 for conveying the ambient air U into the heating apparatus 4.

The treatment chamber 3 is designed here such that merely heated clean gas E can be conveyed by means of the feed apparatus 18 into the treatment chamber 3. The treatment chamber 3 has a closed side wall 14, such that the heated flue gas R cannot enter the treatment chamber 3. Once the flue gas R has been fed into the housing 16, the flue gas R is removed through the housing outlet 23, wherein, here as well, a suction apparatus for the flue gas R can be arranged downstream of the housing outlet 23, although no such suction apparatus is illustrated here.

A microwave sensor 7 is arranged in the treatment chamber 3 for measuring the moisture content of the cocoa bean pieces 1. Depending on the measured moisture, the volume flow of heated clean gas E through the treatment chamber 3 is regulated by means of the volume flow regulation apparatus 8, which is arranged upstream of the treatment chamber 3.

In addition, a mixer 9 is arranged in the treatment chamber 3 for recirculating the cocoa bean pieces 1 during the drying and/or roasting of the cocoa bean pieces 1. In the illustration shown here, only part of the mixer 9 is illustrated.

In FIG. 3 a schematic illustration of a further alternative treatment apparatus 2 according to the invention is illustrated in a partially sectional side view.

The feed of heated clean gas E and heated flue gas R into the housing 16 and the treatment chamber 3 respectively is designed as illustrated in FIG. 2.

In contrast to FIG. 2, the treatment apparatus 2 according to FIG. 3 has a lambda probe 6 in the treatment chamber 3 for measuring the oxygen content, from which the moisture content of the cocoa bean pieces 1 is determined by means of the value pairs between oxygen content and degree of roasting stored in the data processing unit 11. The heated flue gas R removed from the housing 16 is returned by means of a return apparatus 12 to the heating apparatus 4. The volume flow control apparatus 8 for regulating the volume flow of heated clean gas E through the treatment chamber 3 on the basis of the determined moisture of the cocoa bean pieces 1 is arranged downstream of the outlet 10.

The heated flue gas R is conveyed to a mixing apparatus 19, in which the proportion of the flue gas R to be returned to the heating apparatus 4 and in which the proportion to be conveyed from the treatment apparatus 2 can be set. The mixing apparatus 19 is connected to the data processing unit 11 in order to control and/or to regulate the quantity of flue gas R returned into the heating apparatus 4.

In FIG. 4 a treatment chamber 3 according to the invention is illustrated in a partially sectional side view. In a portion, the outer wall 14 of the treatment chamber 3 has thermal insulation 15, which is formed as a double wall and has a diameter D=1.8 m. The mixer 9 is illustrated only schematically.

In FIG. 5 a section along the plane AA according to FIG. 4 is illustrated. Part of the mixer 9 and also the thermal insulation 15 are illustrated in the sectional illustration, said thermal insulation being arranged as a wall on the outer wall 14, thus forming a double wall on the cuter side 5 of the treatment chamber 3.

Exemplary Formulations for the Roasting of Cocoa Bean Pieces

Various examples of roasting processes for cocoa bean pieces will be disclosed hereinafter. Here, the process step “convective” means the guidance of heated gas through the treatment chamber. The process step “conductive” means a heating of the outer side of the treatment chamber by means of a heated gas.

The specified temperatures are the temperatures measured in the heating apparatus. The target variable is the moisture and/or temperature of the food to be achieved.

### EXAMPLE 1

Reduction of the roasting time by discharge of moisture from the cocoa bean pieces by means of convection. The passing of heated gas through the treatment chamber is switched off once the final moisture of 6% by weight is reached. The outer side of the treatment chamber is then heated conductively until the temperature of the food is 135° C.

| Process step | Temperature [° C.] | Target variable |
|---|---|---|
| Convective | 250-300 | final moisture of 6% |
| Conductive | 680-750 | 130 to 140° C. |

### EXAMPLE 2

Prevention of the oiling out of cocoa bean pieces.

| Process step | Temperature [° C.] | Target variable |
|---|---|---|
| Convective | 250-300 | final moisture of 6% |
| Conductive | 680-750 | conductive heating |
| | | for 5 to 20 min |
| Convective | 250-300 | final moisture of 3% |
| Conductive | 680-750 | final moisture less |
| | | than 1.8% |

### EXAMPLE 3

Intensive flavor development with reduced roasting time.

| Process step | Temperature [° C.] | Target variable |
|---|---|---|
| Convective | 250-300 | final moisture of 4% |
| Conductive | 680-750 | 115 to 125° C. |
| Conductive | 580 | conductive heating |
| | | for 5 to 15 min |

### EXAMPLE 4

Smoothing of the flavor profile in order to avoid roasting aromas that are too intense.

| Process step | Temperature [° C.] | Target variable |
|---|---|---|
| Conductive | 680-750 | 105 to 115° C. |
| Convective | 250-300 | 130° C. or final |
| | | moisture less than 1% |

### EXAMPLE 5

Production of stronger roasting notes in the roasted cocoa bean pieces.

| Process step | Temperature [° C.] | Target variable |
|---|---|---|
| Conductive | 680-750 | 105 to 115° C. |
| Convective | 250-300 | Convective heating |
| | | for 10 min or final |
| | | moisture less than 1% |

### EXAMPLE 6

Alternative method for roasting untreated cocoa bean pieces to attain a roasting aroma as occurs when roasting whole beans.

| Process step | Temperature [° C.] | Target variable |
|---|---|---|
| Convective | 250-300 | 115 to 125° C. or |
| | | final moisture less |
| | | than 1% |

FIG. 6 snows a schematic illustration of an alternative treatment apparatus 2 according to the invention with two hot gas entry openings 24 and two hot gas exit openings 23.

The hot gas entry openings 24 are designed as burner flaps, and the hot gas exit openings 23 are designed as exhaust flaps.

The flap position can be changed in different ways in a process as explained hereinafter on the basis of some examples.

### EXAMPLE 7

The product is dried by conductive heating. This is implemented with great energy input. For this purpose, both burner flaps 24 and both exhaust flaps 23 are opened.

As soon as a control variable, for example moisture or oxygen content, falls below or exceeds a predetermined target value, a switchover is made to roasting. For this purpose gas is made to flow gently around the treatment chamber 3, for example diagonally, wherein only one burner flap 24 and an exhaust flap 23 arranged diagonally opposite are opened.

### EXAMPLE 8

The product is dried by convective and conductive heating. Here, a turner flap 24 and an exhaust flap 23 arranged diagonally opposite are opened.

As soon as a control variable, for example moisture, oxygen content or fine piece discharge falls below or exceeds a predetermined target value, a switchover is made to roasting. For this purpose, a switchover is made to purely conductive heating.

### EXAMPLE 9

The product is dried by conductive heating. This is implemented with great heat input. For this purpose, both burner flaps 24 and both exhaust flaps 23 are opened.

As soon as the fine piece discharge exceeds a predetermined target value, a switchover is made to roasting. For this purpose, hot gas is passed gently over the treatment chamber 3, for example diagonally, wherein only one burner flap 24 and one exhaust flap 23, which is arranged diagonally opposite, are opened. Should the fine piece discharge nevertheless reach a critical value again, the extraction can be reduced.

FIG. 7 shows a partially sectional side view of a treatment chamber 3 according to the invention with gas-guiding elements 25. The gas-guiding elements 25 are mounted in the form of guiding plates on the outer side 14 of the treatment chamber 3. The gaps 26 between the gas-guiding plates 25 ensure that the hot gas flows over the treatment chamber 3 along a meandering path. The residence time of the hot gas on the treatment chamber 3 is thus greater than with a direct path of the gas between burner flaps (not illustrated here) and exhaust flaps.

FIG. 8 shows a measurement curve 27 of a microwave sensor 7 during a method for drying and/or roasting a food product, wherein the measurement signal is plotted over time. The generally decreasing course of the measurement curve 27 reflects the decreasing moisture in the treatment chamber 3.

At a moment in time t1, moisture is led into the treatment chamber 3 through the application apparatus 20. On the basis of a peak 28 in the measurement curve 27, it is possible to determine directly that the moisture actually arrives in the treatment chamber 3, and on the basis of the area below the peak 28 the quantity of introduced moisture can be determined.

The moisture is deposited on the product and evaporates, which leads to a sterilization, such that the peak in the measurement curve 27 relaxes again and at a moment in time t2 it is no longer possible to determine any excessive moisture.

With the occurrence of a peak 28 in the measurement curve 27 with sufficient amplitude and/or sufficient enveloped area, a positive detection of an occurred sterilization is thus provided.

If the moisture has fallen below a predefined target value, the process can be ended at a moment in time t3.

1-15. (canceled)

16. A method for drying and/or roasting a food, in a treatment apparatus, comprising a treatment chamber and at least one heating apparatus, wherein the method comprises the following steps:
heating a first gas by the heating apparatus,
heating an outer side of the treatment chamber,
passing heated gas through the treatment chamber, wherein the passing through the treatment chamber can take place prior to the heating, after the heating, or at the same time as the heating of the outer side, and
drying and/or roasting the food in the treatment chamber by the heating and/or by means of the passed-through heated gas,
wherein a sensor is arranged on and/or in the treatment chamber, a control variable in the treatment chamber is determined during the drying and/or roasting on a basis of a measured value, and the heating and/or the passing through of heated gas is/are regulated depending on the determined control variable.

17. The method as claimed in claim 16, wherein the sensor is a moisture sensor.

18. A method for drying and/or roasting a food in a treatment apparatus comprising a treatment chamber and at least on heating apparatus, wherein the method comprises the following steps:
heating a gas by the heating apparatus (4),
heating an outer side (5) of the treatment chamber (3), and
drying and/or roasting the food in the treatment chamber by heating the treatment chamber and/or by means of a passed-through heated gas,
wherein at least one sensor is arranged on and/or in the treatment chamber, at least one control variable in the treatment chamber is determined during the drying and/or roasting on a basis of a measured value, and the heating, the passing of heated gas and/or an extraction is regulated depending on the determined control variable, and the at least one control variable is a quantity of food material guided out from the treatment chamber.

19. The method as claimed in claim 18, wherein heated gas is passed through the treatment chamber, the passing through the treatment chamber takes place prior to the heating, after the heating, or at the same time as the heating of the outer side.

20. The method as claimed in claim 16 wherein the control variable is the moisture of the food or of the food surface, an oxygen quantity, a quantity of food material guided out from the treatment chamber, or combinations thereof, in particular the moisture is determined by a microwave sensor.

21. The method as claimed in claim 16, wherein the heating is regulated via an adjustment of the gas path through the housing.

22. The method as claimed in claim 21, wherein the heating is regulated by defining regions of the housing through which gas is preferably passed by opening and/or closing at least one hot gas entry opening of the housing and/or at least one hot gas exit opening of the housing.

23. The method as claimed in claim 16, wherein a volume flow regulation apparatus for the volume flow of heated gas and/or of gas fed into the heating apparatus is arranged in the treatment apparatus, and the volume flow is regulated depending on the determined moisture.

24. The method as claimed in claim 23, wherein the volume flow is regulated in such a way that a maximum flow rate of the heated gas, at an outlet of the treatment chamber, is less than 25 m/s and preferably less than 20 m/s.

25. The method as claimed in claim 24, wherein the maximum flow rate is regulated in a time-dependent manner.

26. The method as claimed in claim 16, wherein the treatment apparatus is operated in a partial recirculation mode.

27. The method as claimed in claim 26, wherein the treatment apparatus is operated in such a way that heated gas, fed to the outer side, is returned into the heating apparatus at least in a proportion of 50%.

28. The method as claimed in claim 27, wherein fresh gas is mixed with the returned gas.

29. The method as claimed in claim 16, wherein the treatment apparatus comprises a data processing unit in which value pairs of degree of roasting and moisture of the food are stored, the degree of roasting can be determined by a measurement, and the moisture of the food is determined via the measurement and the stored value pairs.

30. The method as claimed in claim 31, wherein the degree of roasting and/or the moisture of the food can be determined by a measurement and the change of the oxygen content in the treatment chamber.

31. A method for verifying a performed sterilization during a method for drying and/or roasting a food in a treatment apparatus comprising a housing, a treatment chamber and at least one heating apparatus, wherein the method comprises:
introducing additional moisture into the treatment chamber, and
detecting a sterilization peak in a measurement curve of a microwave sensor.

32. A treatment apparatus for drying and/or roasting a food, for carrying out a method as claimed in claim 16, wherein the treatment apparatus comprises a treatment chamber and at least one heating apparatus for heating a gas, at least one sensor is arranged on and/or in the treatment chamber for determining a control variable of the food in the treatment chamber, during the drying and/or roasting, in such a way that the drying and/or roasting can be regulated depending on the determined control variable.

33. The treatment apparatus as claimed in claim 32, wherein the treatment apparatus comprises an adjustment apparatus by which the passing of heated gas through the treatment chamber can be adjusted.

34. The treatment apparatus as claimed in claim 32, wherein the sensor is a moisture sensor.

35. The treatment apparatus as claimed in claim 33, wherein the control variable is one of the moisture of the food or of the food surface, an oxygen quantity, a quantity of food material guided out from the treatment chamber, or combinations thereof, and/or in that a moisture sensor is arranged on and/or in the treatment chamber and is formed as a microwave sensor, and/or at least two lambda probes are arranged in the treatment apparatus, a second lambda probe of the two lambda probes is arranged on and/or in the heating apparatus in order to measure the oxygen content in the heating apparatus.

36. The treatment apparatus as claimed in claim 33, wherein the treatment apparatus comprises a guiding device by which the heated gas can be guided through the housing over different paths.

37. The treatment apparatus as claimed in claim 36, wherein the housing has at least two closable hot gas entry openings and/or at least two closable hot gas exit openings.

38. The treatment apparatus as claimed in claim 33, wherein the sensor is formed as a lambda probe for measuring the oxygen content in the treatment chamber.

39. The treatment apparatus as claimed in claim 38, wherein the treatment apparatus comprises a data processing unit in which value pairs of degree of roasting and moisture of the food are stored, the degree of roasting can be determined by a measurement, and the moisture of the food can be determined via the measurement and the stored value pairs.

40. The treatment apparatus as claimed in claim 33, wherein a volume flow regulation apparatus for the volume flow of heated gas and/or of gas fed into the heating apparatus is arranged in the treatment apparatus, and the volume flow can be regulated depending on the determined moisture.

41. A treatment apparatus for drying and/or roasting a food, wherein the treatment apparatus comprises a treatment chamber, which during operation is in contact with the material to be roasted, and at least one heating apparatus for heating a gas, wherein
a portion of an outer wall of the treatment chamber has a thermal insulation, the portion is arranged in the region of the outer wall in which the heated gas can be fed from the heating apparatus to the outer wall,
and/or gas-guiding elements are provided.

42. The treatment apparatus as claimed in claim 41, wherein plates and/or channels are provided at least on a portion of an outer wall of the treatment chamber.
